(19) United States
(12) Patent Application Publication
(10) Pub. No.: US 2001/0012175 A1
(43) Pub. Date: Aug. 9, 2001

(54) SHOCK ISOLATOR FOR A HARD DISK DRIVE

(76) Inventors: KELLY WILLIAMS, BRENTWOOD, CA (US); THO PHAM, MILPITAS, CA (US); TU NGUYEN, SAN JOSE, CA (US)

Correspondence Address: Ben J Yorks, Irell & Manella LLP, 840 Newport Center drive Suite 400, Newport Beach, CA, 92660, US

(21) Appl. No.: 09/168,528

(22) Filed: Oct. 8, 1998

(51) Int. Cl. G11B 17/02

(52) U.S. Cl. 360/97.01

(57) ABSTRACT

An external bumper that is attached to the housing of a hard disk drive. The disk drive may include a disk that is attached to a spin motor. The spin motor may be mounted to a base plate. An actuator arm assembly may also be mounted to the base plate and coupled to the disk. The disk is enclosed by a cover that is attached to the base plate. Elastomeric bumpers are attached to the corners of the cover and the base plate. The bumpers absorb shock loads that are applied to the hard disk drive. By way of example, if the disk drive is dropped on an external surface the bumpers will make contact with the surface and absorb the impact load applied to the drive.

### BACKGROUND OF THE INVENTION

1. Field of the Invention

The present invention relates to a shock isolator for a hard disk drive assembly.

2. Background Information

Hard disk drives contain one or more magnetic disks that are rotated by a spin motor. Each drive also contains a plurality of magnetic recording heads that are located adjacent to the rotating disks. Each head is typically mounted to a flexure arm that is suspended from an actuator arm. The actuator arm includes a voice coil motor which can be energized to rotate the arm and move the heads relative to the disks. The disks and recording heads are enclosed by a cover that is attached to the base plate.

The rotating disks create an air flow that cooperates with air bearing surfaces of the recording heads to create air bearings between the heads and the surfaces of the disks. The air bearings prevent mechanical contact between the heads and the disks. Mechanical contact may damage the disks and/or heads.

The air bearings are only created when the disks are being rotated by the spin motor. To preclude contact between the recording heads and magnetic disks when the spin motor no longer receives power, many disk drives include a latch which secures the heads at the inner diameter of the disks in an area which does not contain data.

Disk drives are typically shipped as separate units that are then subsequently assembled into a computer by a computer manufacturer or an end user. The shipping and handling process can subject the drives to relatively large shock loads. It has been found that large shock loads can cause the heads to slap the disks even when secured in the latched position. Head slapping can create a defect in the disks. It would be desirable to provide an external shock isolator that absorbs shock loads applied to a hard disk drive.

### SUMMARY OF THE INVENTION

The present invention includes an external bumper that is attached to the housing of a hard disk drive. The disk drive may include a disk that is attached to a spin motor. The spin motor may be mounted to a base plate. An actuator arm assembly may also be mounted to the base plate and coupled to the disk. The disk is enclosed by a cover that is attached to the base plate. One or more bumpers may be attached to the external surface of the cover and/or base plate.

### BRIEF DESCRIPTION OF THE DRAWINGS

FIG. 1 is an exploded view of a hard disk drive assembly of the present invention;

FIG. 2 is a perspective view of a bumper of the disk drive.

### DETAILED DESCRIPTION OF THE INVENTION

One embodiment of the present invention includes an external bumper that is attached to the housing of a hard disk drive. The disk drive may include a disk that is attached to a spin motor. The spin motor may be mounted to a base plate. An actuator arm assembly may also be mounted to the base plate and coupled to the disk. The disk is enclosed by a cover that is attached to the base plate. Elastomeric bumpers are attached to the corners of the cover and the base plate. The bumpers absorb shock loads that are applied to the hard disk drive. By way of example, if the disk drive is dropped on an external surface the bumpers will make contact with the surface and absorb the impact load applied to the drive.

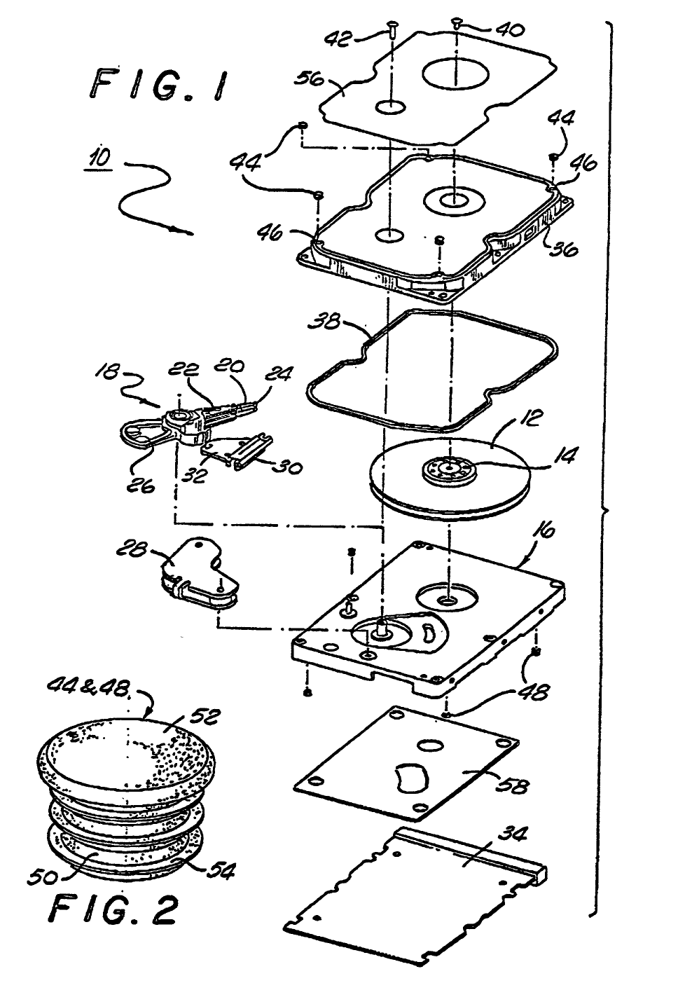

Referring to the drawings more particularly by reference numbers, FIG. 1 shows a hard disk drive 10 of the present invention. The disk drive 10 includes a plurality of magnetic disks 12 that are attached to spin motor 14. The spin motor 14 is mounted to a base plate 16. The spin motor 14 rotates the disks 12.

The disk drive 10 also contains an actuator arm assembly 18. The assembly 18 includes a plurality of flexure arms 20 that are attached to an actuator arm 22. Magnetic recording heads 24 are mounted to the end of each flexure arm 20. In operation, the recording heads 24 “fly” adjacent to the rotating magnetic disks 12 and either magnetize or sense the magnetic field of the disks 12 as is known in the art.

The assembly 18 may further include a voice coil 26 that is attached to the actuator arm 22. The coil 26 may be coupled to a magnet assembly 28 that is mounted to the base plate 16. The coil 26 and magnet assembly 28 create a voice coil motor which can rotate the arm 22 and move the heads 24 across the surfaces of the disks 12.

The heads 24 are typically coupled to a connector 30 by a flexible circuit board 32. The connector 30 is mounted to the base plate 16 and plugged into a mating connector (not shown) of a printed circuit board assembly 34. The printed circuit board assembly 34 contains integrated circuits (not shown) that operate the hard disk drive.

The disks 12, spin motor 14 and actuator arm assembly 18 are enclosed by a cover 36 that is attached to the base plate 16. The cover 36 may be sealed to the base plate 16 by an 0-ring 38. The disk drive 10 may include a first fastener 40 that extends through the cover 36 and attaches the spin motor 14 to the base plate 16. The drive 10 may also have a second fastener 42 that extends through the cover 36 and attaches the actuator arm assembly 18 to the base plate 16.

The disk drive 10 may include a plurality of cover bumpers 44 that are plugged into apertures 46 located at the corners of the cover 36. The drive 10 may also have a plurality of base plate bumpers 48 that are plugged into apertures (not shown) located at the corners of the base plate 16. The bumpers 44 and 48 are preferably constructed from an elastomeric material such as rubber. The bumpers 44 and 48 will absorb mechanical energy such as external shock and vibration loads that are applied to the drive 10.

FIG. 2 shows an embodiment of the bumper 44 and 48. Each bumper 44 and 48 may have a shank 50 that extends from a head 52. The shank 50 is pressed into the apertures of the cover 36 and the base plate 16. The shank 50 may have a plurality of conical shaped collars 54 that secure the bumper 44 and 48 to the cover 36 or the base plate 16.

Referring to FIG. 1, the disk drive 10 may include a top acoustic plate 56 that is attached to the top surface of the cover 36. The acoustic plate 56 may include a damping adhesive that is coated onto a steel plate. The damping adhesive attaches the metal plate to the drive cover 36 and attenuates acoustic energy transmitted into the cover 36. The drive 10 may also have a bottom acoustic plate 58 that is attached to the base plate 16.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive assembly, comprising:
a base plate;
a spin motor mounted to said base plate;
a disk attached to said spin motor;
an actuator arm assembly mounted to said base plate and coupled to said disk;
a cover that is attached to said base plate and which encloses said disk, said cover having an external surface; and,
a cover bumper attached to said external surface of said cover.

2. The assembly as recited in claim 1, wherein said cover bumper includes a shank that is pressed into an aperture of said cover.

3. The assembly as recited in claim 2, wherein said shank includes a conical shaped collar.

4. The assembly as recited in claim 1, wherein said cover bumper is constructed from an elastomeric material.

5. The assembly as recited in claim 1, further comprising a base plate bumper that is attached to said base plate.

6. A hard disk drive assembly, comprising:
a base plate which has an external surface that includes four corners;
a spin motor mounted to said base plate;
a disk attached to said spin motor;
an actuator arm assembly mounted to said base plate and coupled to said disk;
a cover that is attached to said base plate and which encloses said disk, said cover having an external surface which has four corners;
a plurality of cover bumpers that are attached to said corners of said cover; and, a plurality of base plate bumpers that are attached to said corners of said base plate.

7. The assembly as recited in claim 6, wherein said cover and base plate bumpers each include a shank.

8. The assembly as recited in claim 7, wherein each shank includes a conical shaped collar.

9. The assembly as recited in claim 6, wherein said cover and base plate bumpers are constructed from an elastomeric material.
